(19) United States
(12) Patent Application Publication
(10) Pub. No.: US 2011/0275040 A1
(43) Pub. Date: Nov. 10, 2011

(54) MULTIFUNCTIONAL EDUCATIONAL AND ENTERTAINMENT APPARATUS

(76) Inventors: Jorge de la Torre Paniagua, Cleveland, OH (US); Ryan Matthew McCullough, Cleveland Heights, OH (US); Peter Ernest Sciulli, Cleveland, OH (US)

(21) Appl. No.: 13/103,844

(22) Filed: May 9, 2011

Related U.S. Application Data
(60) Provisional application No. 61/332,525, filed on May 7, 2010.

(51) Int. Cl. G09B 19/00

(52) U.S. Cl. 434/236

(57) ABSTRACT

Aspects describe a multifunctional apparatus that provides both educational and entertainment value. The multifunctional apparatus can be a meal plate that comprises a stationary base unit that contains a motor that rotates a platform on which the meal plate is attached. Stationary base unit can also cause the meal plate to vibrate. Stationary base unit comprises means for producing audio output communication and/or visual signals. Controls can be operated through interaction with stationary base unit and/or a remote control device. The meal plate can be interchangeable, wherein a multitude of meal plates can be utilized with a single stationary base unit. The multifunctional apparatus can utilize technology that can synchronize an object, such as a meal plate, with the base.

### CROSS-REFERENCE

This is an application claiming priority to Provisional Application No. 61/332,525 entitled “MULTIFUNCTIONAL EDUCATIONAL AND ENTERTAINMENT APPARATUS” filed May 7, 2010, and hereby expressly incorporated by reference herein.

### BACKGROUND

I. Field

The following description relates generally to an educational and/or entertainment apparatus and more particularly to a multifunctional apparatus that can be used at mealtime or at other times.

II. Background

Today there exists an obesity problem and/or a tendency to adopt bad eating habits not only with children but also with adults. Habits developed during childhood have a lasting effect. Thus, bad eating habits developed during childhood can lead to bad eating habits well into adulthood. Further, many adults have found that they need to relearn (or learn) correct portion control as well as better eating habits.

Meal plates have traditionally been known in the art as stationary units. Further, such meal plates lack interactive entertainment possibilities that draw attention and focus to the food. Meal plate innovations that appeal to children's preferences have generally been limited to the type of material used and/or visual designs. Existing meal plates do not address how to prevent or correct poor eating habits and therefore, the child obesity problem (and adult obesity problem) that exists cannot be sufficiently addressed during mealtime.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with a multifunctional apparatus that provides educational and/or entertainment opportunities. According to an aspect is a meal plate that is selectively attached to a platform to engage a child (or other person) by providing visual, audible, and/or haptic outputs. Since a child can be easily distracted during mealtime (and at other times). The plate or other object can rotate and/or vibrate, which can make the object seem “alive”. In another example, the child can be presented with audible songs, statements, facts, games, and so forth. Further, visual outputs, such as blinking lights can be utilized to draw the child's attention to the plate.

An aspect relates to a multifunctional educational/entertainment apparatus. Apparatus comprises a platform comprising a first attachment means and an object comprising a second attachment means. The first attachment means and the second attachment means are selectively engaged. Apparatus also comprises at least one control for managing at least one function associated with the platform and at least one of a visual, audible, or tactile output that draws attention to the multifunctional entertainment/educational apparatus. The at least one control is an on/off switch. The at least one control is a rotation or a vibration. The at least one control is an audio output or a visual output. According to some aspects, apparatus also comprises a remote control device for controlling operation of the at least one control. The object is dinnerware. The dinnerware is a plate. The object is a children's dinnerware. The object is an electronic children's dinnerware.

To the accomplishment of the foregoing and related ends, one or more aspects comprise features hereinafter fully described and particularly pointed out in the claims. The following description and annexed drawings set forth in detail certain illustrative features of one or more aspects. These features are indicative, however, of but a few of various ways in which principles of various aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

FIG. 1 illustrates a non-limiting, example multifunctional apparatus configured to provide educational and/or entertainment opportunities, according to an aspect.

FIG. 2 illustrates is a bottom perspective view of a non-limiting, example of an external object that can be attached to the platform, according to an aspect.

FIG. 3 illustrates a top perspective view of a non-limiting, example platform of a multifunctional apparatus, according to an aspect.

FIG. 4 illustrates non-limiting examples of an interchangeable plates that can be utilized with the various aspects disclosed herein.

FIG. 5 illustrates other non-limiting examples of interchangeable plates that can be utilized with the various aspects disclosed herein.

FIG. 6 is an exploded perspective view of a non-limiting, example platform, according to an aspect.

FIG. 7 is a cross-sectional view of a non-limiting, example platform in accordance with an aspect.

FIG. 8 is a non-limiting, example circuit diagram of a circuit that controls functions of the example platform, according to an aspect.

FIG. 9 is a photograph of an example platform, according to an aspect.

FIG. 10 is another photograph of the example platform, in accordance with an aspect.

FIG. 11 illustrates another embodiment of an example multifunctional apparatus, according to an aspect.

FIG. 12 illustrates another embodiment of an example multifunctional apparatus, according to an aspect.

FIG. 13 illustrates a system for controlling at least one function of a multifunctional apparatus, according to an aspect.

FIG. 14 illustrates a system for controlling at least one function of a multifunctional apparatus, according to an aspect

FIG. 15 illustrates another aspect of a system, according to an aspect.

FIG. 16 illustrates a block diagram of a computer operable to execute the disclosed aspects.

FIG. 17 illustrates a schematic block diagram of an exemplary computing environment, according to an aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing these aspects.

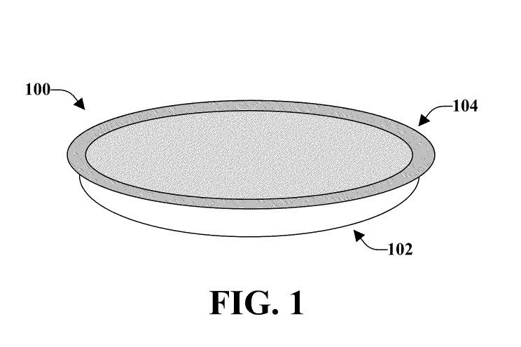

FIG. 1 illustrates a non-limiting, example multifunctional apparatus 100 configured to provide educational and/or entertainment opportunities, according to an aspect. Examples of educational opportunities include lesson plans (e.g., homework), memorization skills, concentration skills, childhood development, improved eating habits, food education, nutritional education, as well as a variety of other educational pursuits that can be realized through audio, visual, and/or haptic (e.g., tactile) feedback. Examples of entertainment include music, songs, stories, fictional characters, trends and fads, as well as other forms of entertainment that can be realized through audio, visual, and/or haptic feedback.

Multifunctional apparatus 100 can provide the educational/entertainment opportunities during a mealtime (e.g., breakfast, lunch, dinner, snacks) or at other times. For example, multifunctional apparatus 100 can be utilized at lunchtime to keep a child engaged and more willing to eat the food on the plate. In another example, multifunctional apparatus can be utilized at a banquet and can draw attention to a cake or other items that are placed on multifunctional apparatus. For example, multifunctional apparatus 100 can be configured to rotate and/or vibrate objects (e.g., food container, dinnerware, bowls, plates, cups, pitchers, and so forth) that can interface with multifunctional apparatus 100. The rotation and/or vibration of the objects can cause a corresponding rotation and/or vibration of items (e.g., food items, drink items, or other items of interest) placed on (or inside) the object.

Multifunctional apparatus 100 is also configured to output various aids (including visual, audio, and/or haptic aids) that facilitate the educational and/or entertainment opportunities. For example, the visual aids can include colored lights, blinking lights, steady lights, still pictures, moving pictures, or other visual items. In another example, the audio aids can include songs, educational information, and other audio communication (e.g., beeps, alarms, and so on). In a further example, the haptic aids can include rotation, vibration, and/or other haptic or tactile feedback.

In accordance with some aspects, the various aids can be activated (turned on) periodically, randomly, constantly, or at other time intervals, which can be time intervals associated with the educational and/or entertainment opportunities and/or based on a user preference. In some aspects, the various aids can be selectively turned on/off (e.g., activated and/or deactivated by a selector switch). Additionally or alternatively, the various aids can be activated automatically and/or manually. For example, in some aspects, the various aids can be activated as a function of a plate (or other object) currently engaged with the base (e.g., through RFID (Radio-Frequency Identification) or other technology), in which the plate (or other object) is automatically identified and synchronized with other portions (e.g., a platform) of the multifunctional apparatus.

As illustrated, the multifunctional apparatus 100 can include a platform 102 (or base) on which an object can be securely engaged. As shown, the object can be a plate 104, such as a dining plate. In some aspects, the object can be a bowl, a drinking glass or drinking vessel, a pitcher, a catering tray, a platter, or any other object. Items that can be placed on or within the object are any items related to food, drinks, or other items that can be placed on (or inside) the object. It should be understood that although the various examples are described herein with respect to a plate and food items, the aspects are not limited to this embodiment and any example described herein can be utilized with other objects and/or items.

The platform 102 is configured to accept the plate 104, where the plate 104 is in secure engagement with the platform 102. For example, the plate 104 can include a portion, such as on the underside (e.g., non-eating side) of the plate 104 that can securely connect with a portion of the platform 102. Further information related to the engagement of the base and the plate (or other object) will be provided below.

In some aspects, the platform 102 is a standalone unit that can operate separately from the plate 104. For example, the platform 102 and plate 104 can be detachable (e.g., separate pieces). In this configuration, the plate 104 can be removed from the base for cleaning, such as in a dishwasher, or for disposal (e.g., if the plate is a one-time use or disposable plate). Separation of the plate from the platform can allow a multitude of plates to be used with the disclosed aspects.

According to some aspects, the base and plate can be a single unit (e.g., non-detachable). For example, the base and plate can be can be disposable (e.g. intended for a single use) and/or reusable (e.g., sealed together in a waterproof manner that allows the entire unit to be cleaned for reuse).

Platform 102 can be constructed from various materials including plastic. For example, platform 102 can be a molded plastic encasement that contains mechanical and/or electrical components. According to some aspects, platform 102 can comprise a heating element that keeps at least a portion of the plate (or other object, including food or other items) on the plate 104 warm. Additionally or alternatively, at least a portion of the platform 102 can be sealed to help mitigate liquids and/or food particles from entering the platform 102.

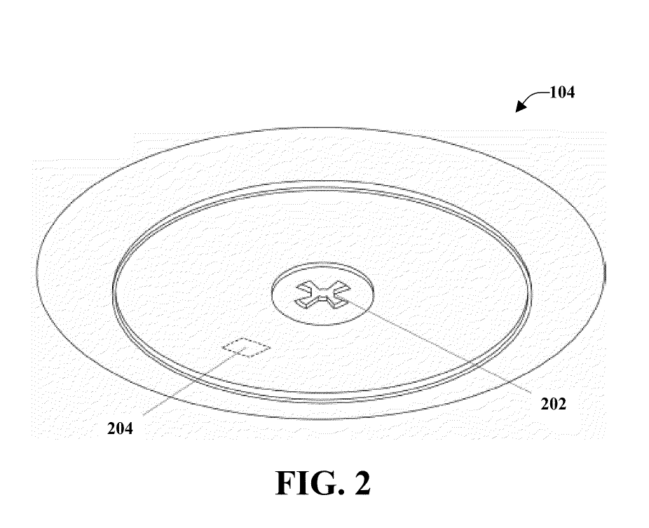

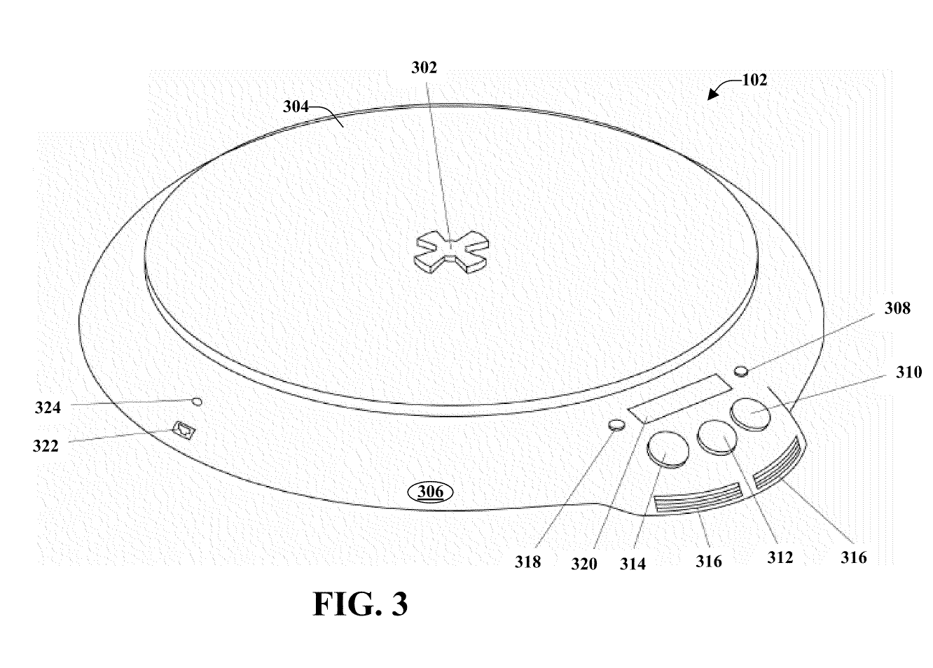

Reference is now also made to FIG. 2 and FIG. 3. FIG. 2 illustrates is a bottom perspective view of a non-limiting, example of an external object, shown as a plate 104, that can be attached to a platform, according to an aspect. FIG. 3 illustrates a top perspective view of a non-limiting, example platform 102 of a multifunctional apparatus, according to an aspect.

The plate 104 (or other object) can include an eating surface and a non-eating surface (or underside). The non-eating surface can include a first connection means 202 that is configured to engage a second connection means 302 of platform 102. The engagement of first connection means 202 with second connection means 302 allows the plate 104 to interface with a movable portion 304 of platform 102. The movable portion 304 is configured to rotate and/or vibrate. For example, the first movable portion 304 and second connection means 302 can rotate as a unit, which in turn rotates the plate 104. In another example, the second connection means 302 can rotate independently, which in turn can rotate the plate 104. Thus, there can be one or more portions of the platform 104 which can rotate and/or vibrate while other portions of the platform 104 remain stationary and do not rotate and/or vibrate. However, in some aspects, the entire platform 104 rotates and/or vibrates.

In an example, the movable portion 304 (and/or other portions, hereinafter referred to simply as movable portion 304) can rotate in a clockwise direction and/or a counterclockwise direction. Further, movable portion 304 can change direction, as a function of the object (e.g., plate) and functionalities associated with the object (as determined through synchronization with the object, manual selections, and/or other criteria). For example, the plate might rotate in a clockwise direction. However, if it is determined that the child needs to eat more vegetables, the rotation can reverse direction (e.g., rotate counterclockwise) and, when the vegetables are directly in front of the child, rotation can stop and the child can be prompted to eat the vegetables. The prompt can include a verbal command to eat the vegetables. In another example, the prompt can be visual in which a portion of the plate that contains the vegetables can illuminate (e.g. lights can turn on) to draw attention to the vegetables.

In some examples, the placement of the object on the movable portion 304 causes the object (e.g., plate) to automatically rotate and/or vibrate. Further, placement of the object on the base can cause verbal and/or visual actions to occur. For example, an RFID 204 or other identification technology and/or communication means associated with the object can be detected by platform 102 (or a component of platform). Such identification can cause platform to associate the object with a certain program or routine that is associated with the object. For example, if the object (e.g., plate) has a depiction of a fictional character, song(s) associated with the fictional character can automatically begin playing as well as other visual, audible, and/or haptic outputs. The various outputs can start at about the same time as the plate is securely engaged with the platform or at a different time (e.g., when the multifunctional apparatus is manually activated, when presence of a user is detected, and so forth).

In an example, rotation of the object (e.g., plate) can be a function of a song associated with the plate. For example, a Star Spangled Banner song can be associated with a Fourth of July holiday plate. As the song is played, lights can display, representing fireworks. In some aspects, the plate can vibrate at substantially the same time as the lights are illuminated to further represent fireworks. Further, the plate can rotate in a first direction and then change to rotate in a second direction, which can be recursive (e.g., the direction continues to change through the song or throughout the entire mealtime).

In a further example, the song associated with the plate can correspond with food items on the plate. For example, a user (e.g., parent) can select which items that child is eating (e.g., fruits), and, based on the manual selection, a song related to the benefits of fruit and how good fruits are can be played. In some aspects, meals can be provided in prepackaged form, wherein the song (or other audible output) discusses the nutritional benefits of the meal, for example.

In another example, the multifunctional apparatus 100 can be utilized with a catering or other gathering function. For example, various items can be placed on the platform, which can turn or rotate, allowing persons on different sides of a table the opportunity to be presented with the items on the plate as the plate is rotated. For example, multifunctional apparatus can be a spinning tray used at a gathering and cookies or pastries can be placed on the tray. In this example, the multifunctional apparatus can rotate automatically. In some aspects, an audible output of multifunctional apparatus can be similar to the events at the gathering (e.g., if music is being played over a loudspeaker the music can also be played over speakers associated with the multifunctional apparatus). However, the disclosed aspects are not so limited and other audible sounds can be played through speakers of multifunctional apparatus.

In some aspects, multifunctional apparatus can be used for various games that utilize rotational aspects and/or a vibrational aspect as well as games that utilize sounds and/or visual cues. For example, the games might only utilize sounds or visual cues and not the rotational aspect and/or the vibrational aspect. In some aspects, each of the sounds, visual cues, rotation, and vibration (as well as other haptic elements) can be selectively activated and/or deactivated by the user or by someone else (e.g., a parent using a remote control to interact with multifunctional apparatus). In an aspect, the controls associated with the platform can be selectively locked or disabled.

In some aspects, plate 104 (or other object) can be substantially the same size (or diameter) as platform 102. However, plate 104 can be smaller or larger than platform. For example, if the plate (or other object) is round, the diameter of plate and platform can be about the same diameter. In another aspect, the diameter of plate can be larger than the diameter of the platform, which can allow for ease of removal and placement of the plate on the platform and can also provide the visual effect that the plate is rotating off (or away from) the table.

Further, although plate 104 and platform 102 are shown as generally circular, the disclosed aspects are not limited to a circular design and other geometric shapes can be utilized with the disclosed aspects. For example, the object and/or platform can be generally circular, oval, rectangular, square, or other geometric shapes. Further, the object and platform need not be the same shape.

According to some aspects, platform 102 can be configured to be shock absorbent and can also be configured to have the durability to rotate an object that weighs at least a few pounds as well as items placed on the object that can contribute to the weight of the object. In some example, object can rotate and vibrate regardless of the weight placed on the platform.

Additionally or alternatively, platform 102 can be configured to withstand stoppage by a child (or other person) playing with the platform or stabbing at items on the platform (or on the plate placed on the platform). In an example, a child may attempt to stop the plate with finger and/or a fork or other utensil. A safety mechanism included in platform 102 can temporarily turn the rotation and/or vibration off when pressure (above a certain amount) is applied. When the pressure is removed, the rotation and/or vibration can start again automatically. In such a manner, motors included in platform can be protected and power (as well as other resources) can be conserved. Further stoppage of the rotation and/or vibration can allow the user the opportunity to select an item (e.g., pastry) from the plate.

As briefly mentioned, plate 104 can comprise a first attachment means 202 and platform can comprise a second attachment means 302. As illustrated, the second attachment means 302 is configured to accept and securely engage the first attachment means 202 associated with an underside of the plate 104.

For example, when the plate 104 is placed onto platform 102 (or onto movable portion 304), the first attachment means 202 and second attachment means 302 can be aligned and locked together, which can securely attach the plate 104 to the platform 102. According to some aspects, first attachment means 202 is an attaching mechanism that attaches a corresponding counter-attachment mechanism (e.g., second attachment means 302) of the platform 102. For example, first attachment means 202 can comprise a female connector and the second attachment means 302 can comprise a male connector. However, the disclosed aspects are not so limited and the platform can include the female connector and the plate (or other object) can include the male connector. Further, in some aspects, different types, shapes, and/or configurations of connectors than the connectors illustrated can be utilized. For example, magnets can be utilized to securely attach the object to the platform.

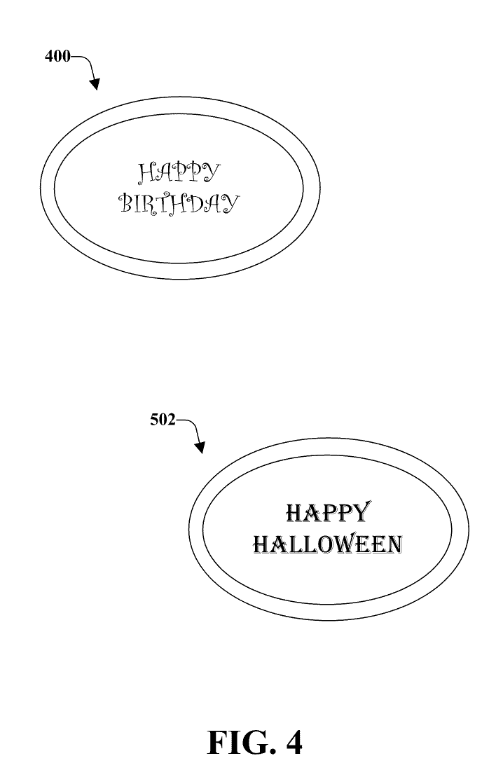

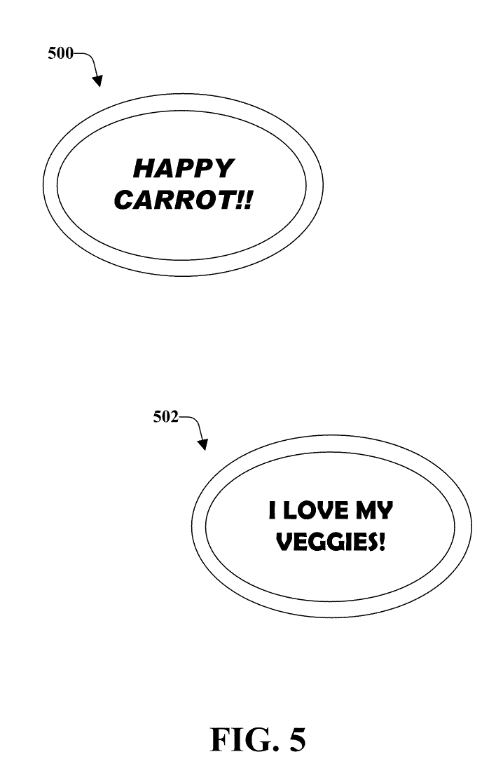

FIGS. 4 and 5 illustrate non-limiting examples of interchangeable plates that can be utilized with the various aspects disclosed herein. For example, a plate can be an interchangeable plate, wherein a multitude of plates can be interfaced with the platform depending on a user preference. The plates can have various pictures, photographs, words, numbers, or other visual representations. For example, the plate (or other object) can comprise any design, picture, photograph, brand, cartoon, movie, Internet site, toy, game, character, restaurant, entertainer, and so forth, that might be desirable for viewing by a child or an adult.

Each plate can have a different design and can be linked or associated with a song, visual effects, rotation, and/or vibration. In some aspects, plate can include a permanent design. For example, plates can be easily purchased at a department store or specialty store. Further, plates can be shared with others and can be recognized by a multitude of platforms (e.g., platforms can recognize and synchronize with a variety of different plates or other objects).

In an example, the plate can be associated with a veggie song (for enticing a child to eat their vegetables), a happy birthday song, holiday songs, or a multitude of other songs. If the child becomes bored with the song or if other songs are desired, other songs (or visual aids) can be downloaded into platform (or other control component) and can be manually selected (e.g., through a menu selection). For example, the audio aids and/or visuals aids can be downloaded from the Internet or obtained through other means (e.g., a personal device). In accordance with some aspects, the visual aids and/or audio aids can be created by the user (or another person) and stored within a memory of platform.

FIG. 4 illustrates a “Happy Birthday” plate 400 that can include the words “Happy Birthday” as well as pictures or other graphics (not shown). The “Happy Birthday” plate 400 can include an RFID tag, or other identifier, indicating that it is a “Happy Birthday” plate. When the plate is engaged with a platform, the platform can interpret the RFID tag and can access a program associated with the “Happy Birthday” plate. In an example, the plate can be a Happy Birthday plate that can command (through an RFID tag) when lights turn off and on. When the plate is attached to platform and power is applied, a Happy Birthday song is played. For example, a light can flash every two seconds and stop when birthday song is complete. Thus, when the platform is manually activated (e.g., through an on/off switch) or when the platform is automatically activated (e.g., based on synchronization with the plate), output related to a birthday is performed. Such performance can include an output of a birthday song, lights that indicate an age of the person, rotation of the platform to allow the person having the birthday celebration to blow out candles on the cake, as well as other outputs. In an example, the birthday song can be modified through a user control in which the name of the person can be input such that when the song plays, it is personalized. In a similar manner, the age of the person can be manually input through a user interface for further personalization.

Also shown in FIG. 4 is a “Happy Halloween” plate 402, which can include the words “Happy Halloween” and graphics (not shown) associated with Halloween (e.g., pumpkins, bats, ghosts, and so forth). The Happy Halloween plate can also include an RFID tag or other identification means such that when engaged with a platform, the plate and platform automatically synchronize and functionality associated with Halloween are output. For example, scary sounds can be output as well as lights that illuminate the wording and/or graphics on the plate.

FIG. 5 illustrates further examples of non-limiting plates that can be utilized with the disclosed aspects. Depicted is a “Happy Carrot” Plate 500 that can include wording and/or graphics (not shown). In an example, a happy carrot plate 500 can synchronize with the platform and information related to carrots and why eating carrots is important can be output. In another example, an “I Love My Veggies” plate 502 is shown, which can include wording and/or graphics (not shown). When synchronized with the platform, usage of this plate can output benefits of eating vegetables, information related to the different types of vegetables, as well as other educational and/or entertainment information. In another example, the vegetable plates illustrated in FIG. 5 can rotate and/or vibrate to draw attention and focus to a vegetable section of the plate. In another example, it is detected that the child (or other person) has not taken an item off the plate in a certain amount of time (e.g., two minutes, three minutes, and so forth) and/or if less vegetables have been eaten than other items on the plate. In this case, the plate might rotate automatically so that the vegetable section is directly in front of the child or another type of output (e.g., vibration, lighting effects, sounds, and so forth) can be presented to draw attention back to the plate.

It should be understood that a wide variety of objects (including plates) can be utilized with the disclosed aspects. Such objects can be related to various occasions, including holidays and/or special events. Some objects can be related to likes (or preferences) of the user (e.g., a favorite fictional character, a favorite entertainer, a favorite movie, and so forth). Other objects can relate to educational purposes. For example, if a child is to memorize the Gettysburg Address, the object can include patriotic themes (e.g., wording and/or graphics) while an audible output recites the Gettysburg Address (in an attempt to help with memorization). In another example, the child may be learning the alphabet and thus, the alphabet is shown on the object while an audible output recites the alphabet (in order) while visual outputs (e.g., lights) illuminate each letter as the alphabet is recited. These and a wide variety of other educational and/or entertainment opportunities exist with the aspects disclosed herein. In an example, a teacher or school can provide the students with one or more plates that correspond with a current teaching curriculum.

In accordance with some aspects, one or more articles can be operatively attached around a perimeter of platform 102 (or plate 104). In an example, the article(s) can rotate with the plate 104. In some aspects, the article(s) can rotate in a direction opposite the rotation of the plate. For example, the plate can rotate in a clockwise direction and the article(s) can rotate in a counterclockwise direction. For example, the article(s) can be ballerinas (for a girl) that rotate as a ballet song is being played. In another example, the article(s) can be fruits and vegetables, associated with a vegetable portion of the plate, that rotate with the plate.

In some aspects, a cup and/or cup holder can be located around the perimeter of the platform. The cup and/or cup holder can rotate and/or vibrate at substantially the same time as the plate. In some aspects, the cup and/or cup holder (or other articles) might be stationary, where the plate rotates and/or vibrates and the cup and/or cup holder remain stationary.

According to some aspects, a plate can be provided in a prepackaged food/plate form (e.g., plate can be moved from store shelf, to freezer, to microwave/stove, to dinner plate). The food can be shaped, such as in animal shapes, which can be useful to attract a child's attention. For example, a jungle plate can have various food items shaped like a lion or other jungle animal, as well as other food items that represent other jungle features (e.g., applesauce can represent quicksand, corn kernels can represent rocks or logs). Through interaction with the multifunctional apparatus, mealtime can be turned into a game of walking through (and surviving in) a jungle.

In another aspect, the plate can be a combination plate/food that is prepackaged and that is associated with various “points”. For example, some diet programs utilize points that are used to teach a person (child or adult) how to proportion their meals. An RFID tag (or other identification mechanism) associated with the plate can provide information related to the points, which can be presented to the user with information about how to manage and control portion sizes. In accordance with some aspects, the points can be associated with a color scheme (e.g., which can be represented by lighting or through color coding on a plate or other object).

In another example, the points can be utilized as a game, wherein the child is awarded points based on what is being eaten (e.g., five points for fruits and vegetables, zero points for dessert, and so forth).

In some aspects, a related fork, spoon, knife, and/or other utensils can communicate with multifunctional apparatus using technology such as RFID, Bluetooth, pressure sensors, detection sensors, and/or other sensing or identification techniques. For example, utensils can be utilized to track movement and the child's eating behavior. For example, if the plate has a designated “vegetables” section, the multifunctional apparatus and/or utensil can respond with lights or sounds to reward the child for eating vegetables, as determined by movements of the utensil in the designated plate section, for example.

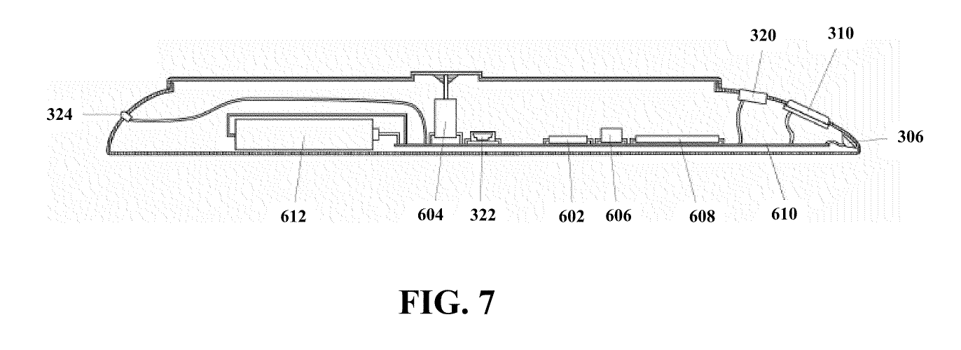

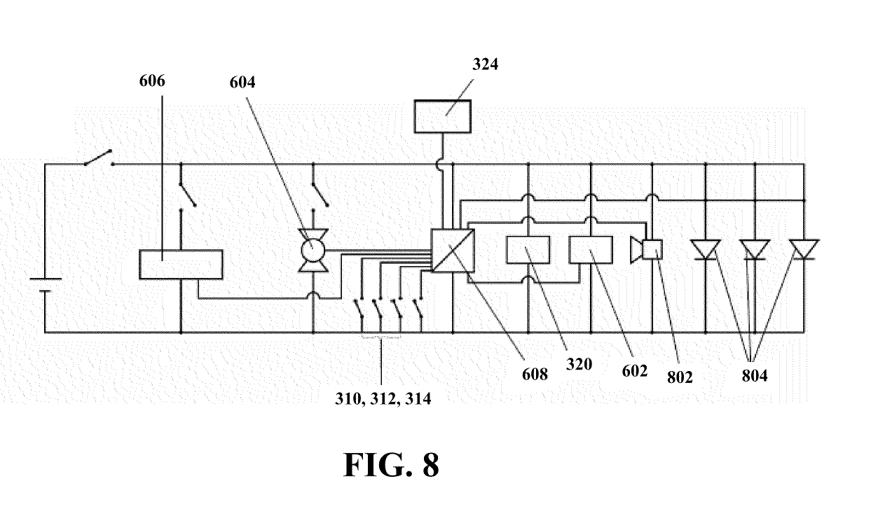

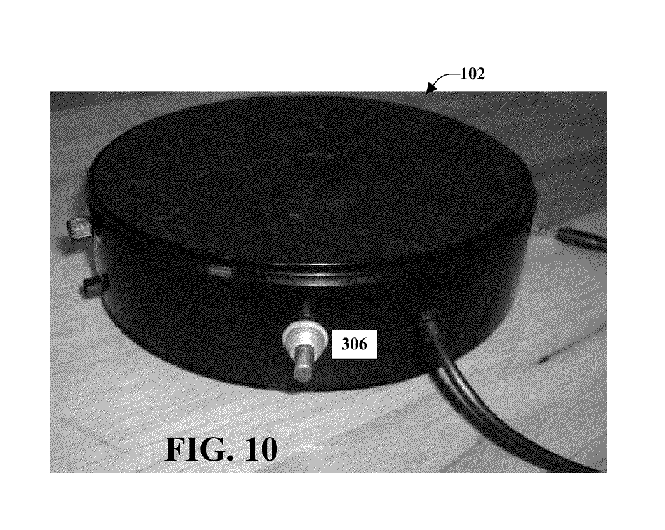

With reference now to FIG. 3 and FIGS. 6 to 10, various control functions can be associated with platform 102. It should be understood that although these various functions are illustrated and described as being integrated with the platform 102, the disclosed aspects are not limited to this implementation. In accordance with some aspects, the various control functions can be located remote from platform 102, such as in a remote control device. In this aspect, the multifunctional apparatus and remote control device communicate wirelessly. In other aspects, the various control functions can be included in the plate of other object (e.g., a separate platform is not utilized).

In some aspects, multifunctional apparatus 100 is configured to utilize WiFi technology to communicate with other devices. Such devices include video game platforms, such as Nintendo Wii, Microsoft Xbox, Sony Playstation, and so forth. In these aspects, multifunctional apparatus 100 can be utilized as a user interface for gaming applications.

For example, if the multifunctional apparatus 100 is being used by a child, a parent might desire to control the functions, rather than allowing the child to control the functions. According to an aspect, the control functions are integrated into the remote device (e.g., remote control) and are not integrated into the platform 102 but are only integrated in the remote control device. However, according to other aspects, the control functions are integrated into both the platform 102 and the remote device.

For example, platform 102 can include an on/off switch 306, which can be a depressible button, a toggle switch, or another type of selector. On/off switch 306 can be activated to provide power to platform 102 (and movable portion 304) and can allow the various functions (e.g., visual, audible, haptic) associated with the platform 102 to be utilized. In accordance with some aspects, platform 102 can include an indentation in which the various user interfaces (controls, display) are located. The indentation can mitigate food or other items being spilled on the controls. Further, the various user interfaces can be sealed, which can mitigate food particles and liquid from damaging the user interfaces.

In accordance with some aspects, on/off switch 306 does not have to be manually activated (e.g., turned on) in order to start the functions associated with platform 102. According to some aspects, plate 106 comprises an RFID tag 204 (shown in FIG. 2). RFID tags can be either active RFID tags or passive RFID tags. An active RFID tag contains a battery (or other power source) and can transmit signals without aid from an external source. A passive RFID tag does not contain a power source and relies on an external source to provide power and to invoke signals from the tag. Some passive RFID tags can include a power source but rely on an external source to invoke a signal from the tag.

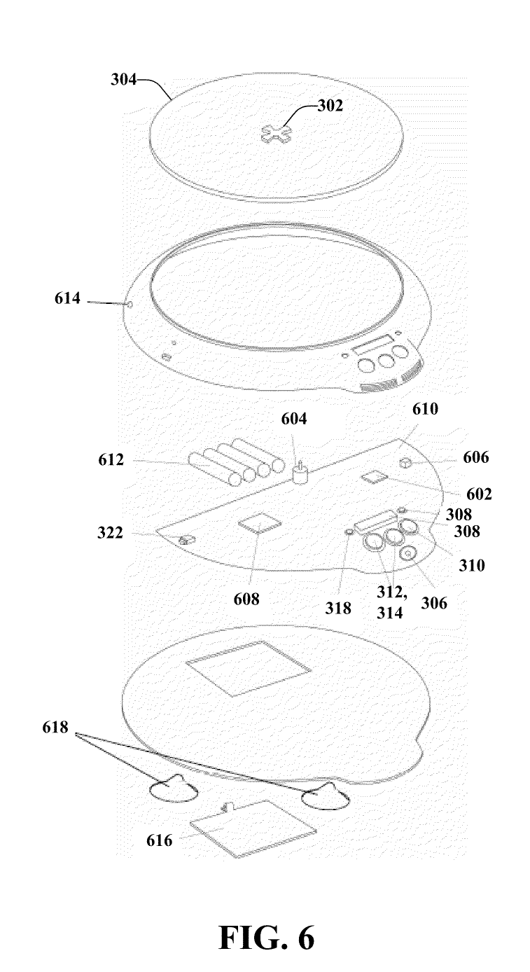

According to an aspect, RFID tag 204 associated with the plate 104 is a passive tag, without a power source. Further to this aspect, platform 102 can include an active RFID reader 602 (FIG. 6) that can communicate with the RFID tag 204 associated with the object (e.g., interchangeable meal plates) that is to be placed on platform 102. In another aspect, the RFID tag 204 associated with the plate 104 (or other object) is an active tag. Upon detection of the RFID tag 204 by the RFID reader 602, the platform can synchronize its functionality as a function of the plate, which has been installed on the platform.

In accordance with some aspects, an RFID is not associated with the plate 104. Further to this aspect, a user (e.g., child, parent) can select a desired action or series of actions through interaction with a user control, such as by selecting a song and associated visual aids and/or haptic aids from a menu or through other selection means. In some aspects, an RFID tag (or other identification means) is included with the plate (or other object), however, the functionality associated with the RFID tag can be selectively overridden (e.g., by a manual selection of different outputs). Selectively overriding the RFID tag, at least temporarily, can allow the user to further customize the dining experience.

In accordance with some aspects, platform 102 is configured to automatically detect the presence of a user. For example, platform 102 can be equipped with speech recognition, voice recognition, and/or biometric capabilities. With one or more of these capabilities, platform 102 can detect the presence of the user and automatically activate the multifunctional apparatus 100. In accordance with some aspects, detection of the user can be enabled through an external device associated with the user (e.g., through wireless communication), such as a wristband or another wearable item that can interact with platform 102 (e.g., the wearable item is equipped with a passive RFID or other device). In accordance with some aspects, multifunctional apparatus 100 is configured to detect the presence of the user based on the presence of a personal device (e.g., cell phone, personal digital assistant (PDA), laptop, or other electronic device, which can be a mobile device). In this aspect, the platform can be configured to associate the personal device with a particular user and can activate one or more functions based on the presence of the user. With automatic detection of the presence of the user, the multifunctional apparatus can also detect when the user is no longer present and can automatically stop the functionality of multifunctional apparatus to conserve resources, including resources associated with a power source (e.g., batteries).

In some aspects, at least one selector 308, such as a depressible button, can be activated to control a rotating motor 604. The rotating motor 604 can rotate the object or plate 104 (as well as any movable portion of platform) at a variable speed, constant speed, and/or random speed. Motor can also stop and start the rotating motion. The speed and/or operation of the rotating motor 604 can be configured by a user and/or can be determined based on information contained in RFID tag 204 associated with the object, according to an aspect. In an example, rotating motor can be a variable speed rotation motor. The rotating motor 604 can include, or can be associated with, means for determining whether (or not) an object has been securely attached to platform 102. If the object is not securely attached, the motor might be disabled, for safety reasons. For example, if the child (or other user) attempts to remove the plate (or other object) during operation (or if the plate/object becomes dislodged for any reason), a safety mechanism can be triggered, which can automatically cause shutdown of the motor (or other actuation means).

Rotation, vibration, audible, and visual aids can cause the child (or other person) to focus on the meal. In an example, the disclosed aspects can be utilized as a therapeutic aid for patients of dementia and/or other related (or unrelated) mental disorders, to encourage eating by promoting focus on the meal. Further, the meal can be turned into a game. For example, pieces of fish, chicken, meat, or other foods can be placed on the plate. The child can be instructed to “reel in” the fish (or other food item) and eat the fish. This can engage the child to not only focus on the meal, but can also improve the child's dexterity and/or cognitive skills.

Other controls, illustrated as three controls 310, 312, 314, can be utilized to control various functions associated with the multifunctional apparatus 100. Although three controls 310, 312, 314 are illustrated, the disclosed aspects are not limited to three controls and any other number of controls can be utilized with the disclosed aspects. The controls 310, 312, 314 can be, for example, depressible buttons, selector switches, or can be associated with a touch screen.

In an example, a control can be utilized to control audio functions. For example, platform 102 can include one or more speaker outputs, shown as two compartment grills 316, wherein audio from audio speakers 802 can be conveyed to a user through the speaker compartment grills 316. In accordance with some aspects, the one or more speaker outputs can be located at different positions around the platform 102. For example, a first speaker output can be located on a first side of platform 102 and a second speaker output can be located on a second side of platform 102. There can be any number of speaker outputs associated with platform and the speaker outputs can be located at any location on platform 102. According to some aspects, any audio associated with the multifunctional apparatus can be conveyed to the user through a headset or headphones, wherein a headphone jack is incorporated into the platform 102 to allow the headphones to be used or not used, as desired by a user (e.g., based on the environment in which the multifunctional apparatus is being utilized). In some aspects, the audio associated with the multifunctional apparatus can be conveyed wirelessly through speakers that are located remotely from multifunctional apparatus.

Another control can be utilized to control a vibration mechanism 606 associated with the platform 102. Vibration can be utilized to engage a user, such as a child. For example, dessert might be gelatin. Applying vibration to the plate can cause the gelatin to move or come “alive”, which can be delightful to the child (as well as to adults). In another example, foil covered chocolate bars, in the shape of cars or trucks, can be placed on the plate as one or more dessert items. Vibration can cause the “cars” to move around the plate, which can simulate car racing. The movement can cause the child (or adult) to focus on the desert, which can raise awareness of what is being eaten (or what should not be eaten or what should be eaten in moderation). In accordance with some aspects, vibrating mechanism 606 (or a component associated with vibrating mechanism 606) can detect the presence (or absence) of an object. If the object is not security attached to platform 102, vibrating mechanism 606 (or another component) can disable the vibration function, for safety reasons.

In another example, a control can be utilized to control a multimedia production. Platform 102 can also include an optional display or screen 320. The screen 320 can be a liquid crystal display (LCD) screen or another mechanism that renders information to a user. For example, screen 320 can provide communication to the user through visual means, which can allow the user to operate the multifunctional apparatus 100. For example, the user can select the outputs through interaction with a scroll down menu or other selection menu. In accordance with some aspects, screen 320 is a touch-screen that allows a user to interact with the multifunctional apparatus 100 and control one or more functions. For example, the screen can be larger than the screen displayed. Further, the screen can be located at another position on platform than the position depicted. In some aspects, a screen is not associated with the platform.

Also associated with platform 102 can be a communication connection means 322 configured to provide a connection with one or more external devices, such as a personal computer. In an example, the communication connection means 322 is a universal serial bus (USB) port.

One or more visual indicators 324 can be associated with platform 102. Although illustrated on the side of platform 102, the one or more visual indicators 324 can be located at other potions of platform. For example, one or more visual indicators can be located under the movable portion, which can allow portions of the object placed on the platform to illuminate. In an example, visual indicators can be light emitting diodes (LEDs) 804. Visual indicators 804 can operate separately or in conjunction with other multimedia components (e.g., audible output, vibration, rotation, and so forth).

With reference to FIGS. 6, 7, and 8, platform 102 can comprise a microprocessor 608 configured to control operation of the multifunctional apparatus 100. An electronic mounting board 610 to which other components can be affixed can also be included in platform 102. Memory can also be operatively associated with platform and/or an RFID tag. It should be appreciated that memory (or data store) components described herein can be either volatile memory or nonvolatile memory, or can include both volatile and nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of example and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

A power source 612 (shown as batteries) can be included within platform 102 and/or can be operatively connected to platform 102. For example, the power source 612 can be a rechargeable battery unit that provides power to the apparatus. Battery power can provide portability (e.g., multifunctional apparatus can be utilized on a camping trip). In another example, power source 612 can be external to platform and connected to platform 102 through a plug or alternating current (AC) connection 614 (e.g., attachable to a power outlet in a user's home or another location). A cover 616 can provide easy access to internal components. Further, the cover 616 can be configured to seal the internal components to mitigate damage if liquid, for example, comes in contact with the platform.

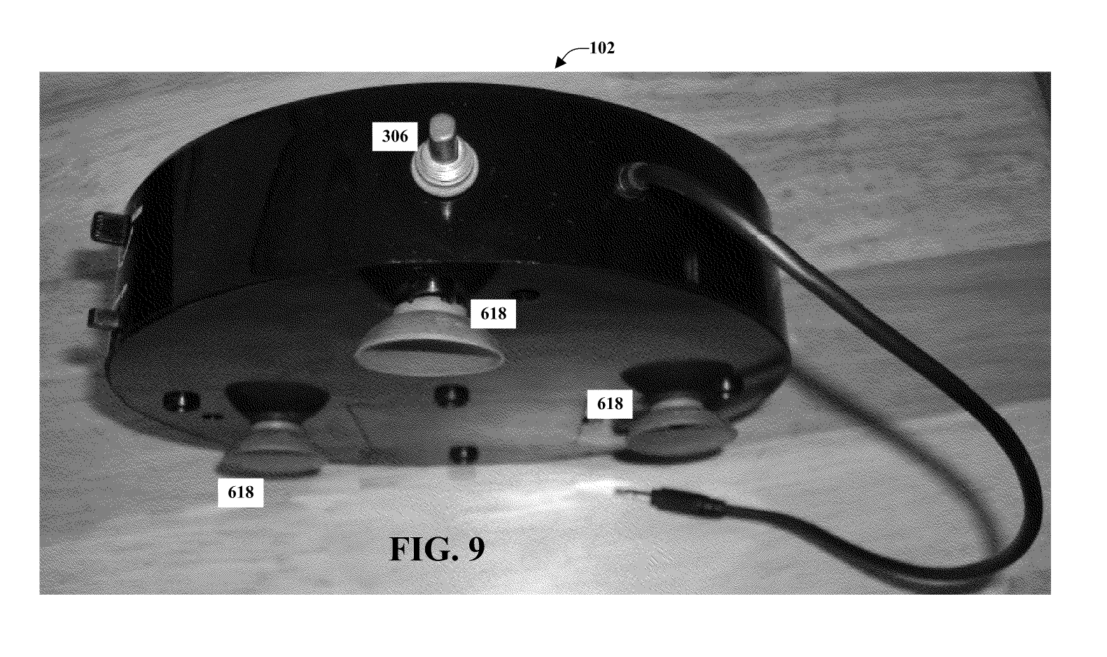

With reference to FIG. 6 and FIG. 9, in accordance with some aspects, one or more securing means can be affixed to the bottom of the platform. The securing means can allow the platform to be securely attached to a table or to another surface. The securing means can be suction cups 618, as illustrated. For example, suction cups can temporarily attach the platform 102 to the table or to the other surface, which can mitigate a child from moving the multifunctional apparatus 100 and spilling food and/or liquids. However, it should be understood that the disclosed aspects are not limited to suction cups as a securing means and other manners of interfacing the multifunctional apparatus with a surface, such as a table, can be utilized.

According to some aspects, a timer can be included in multifunctional apparatus 100. The timer can be configured to be selectively started and stopped (manually and/or automatically). For example, a child might not have a desire to eat dinner and his mother wants the meal to be finished in a certain amount of time (e.g., twenty minutes). The mother can set a timer, which can include (or be associated with) an alarm. For the child, this can be exciting game because when alarm goes off, the child has to be finished with the meal (and might get a gift or another form of positive reward). The timer can be selectable and can be set for any amount of time (e.g., thirty minutes, five minutes, fifteen minutes, and so forth). The timer can also be turned off manually or automatically. For example, the timer can stop automatically when the child completes the meal before the timer expires, which can be detected by weight (e.g., by comparing the starting weight with an ending weight, detecting the food has been eaten when substantially all the weight placed on the object has been removed) or through other manners.

In some aspects, the child can be provided visual cues related to the amount of time remaining. For example, if the timer has a duration of twenty minutes, a green light can be output for the first five minutes. During minutes six through fifteen, a yellow light can be output. When there are five or less minutes remaining, a blinking yellow light can be output. When the timer has expired (or when there is less than one minute remaining, for example), a red light can be output. The red light can be illuminated and an alarm sounded at about the same time. At about the same time as the timer expires, the outputs provided can be stopped. For example, if the plate is rotating, the rotation stops. If vibration is occurring, the vibration stops at about the same time as the timer expires. Further, visual and/or audible outputs can stop at about the same time as expiration of the timer.

In accordance with some aspects, an audible output indicates the amount of time remaining (e.g., “You have ten minutes remaining, eat your veggies!”). In this manner, the child can hear the time remaining. In some aspects, both visual and audible outputs can be utilized to reinforce the time aspects disclosed herein.

In accordance with some aspects, platform 102 comprises sensors that can detect whether food is remaining on the plate 104. The sensors can be configured to detect an amount of food that has been eaten (or that still needs to be eaten).

In another aspect, multifunctional apparatus can comprise food recognition mechanisms. For example, the plate can include compartments in which various food items are placed (e.g., a first compartment for meat products, a second compartment for vegetables, a third compartment for breads, and so forth). A multitude of weight sensors can be associated with the compartments.

Further, in some aspects, each compartment can be associated with a food selector, wherein the user (or another person) can select an item included in the compartment (e.g., fried chicken in the meat section). As a function of the weight and the food selected, nutritional information associated with the item can be output. In an alternative embodiment, the food selector can include an interface that allows the ingredients of the food to be entered, where the nutritional content is output as a function of the weight and the ingredients. In an example, the nutritional content can be utilized at parties, weight control meetings, hospitals, schools, and other institutions. In some aspects, historical nutritional information can be retained and associated with a user. Additionally or alternatively, the nutritional information can be transmitted (e.g., through wireless and/or wired means) to an external device, such a computer or the Internet. The transmission of nutritional information can allow the multifunctional apparatus to interface with various weight control programs and/or applications. This can allow for more accurate tracking and/or for automatic tracking (e.g., the user does not have to remember to enter the information later), which can be helpful in an attempt to lose (or gain) weight.

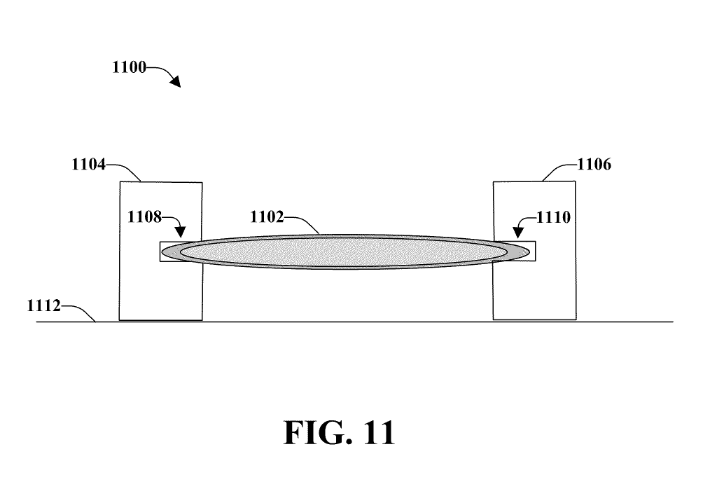

FIG. 11 illustrates an example embodiment of a multifunctional apparatus 1100, according to an aspect. In this example an object, illustrated as a plate 1102, is engaged between a first base 1104 and a second base 1106. Each base includes respective receiving portions 1108, 1110 that are configured to accept the plate 1102. For example, instead of securing the plate on a platform, the plate is engaged within the receiving portions 1108, 1110. The plate can be engaged in a secure manner, whereby various safety mechanism are utilized (e.g., plate stops rotating and/or vibrating if an unsafe condition is detected). In this example, a platform is not utilized to provide the functions (e.g., rotation, vibration, visual, audible). Instead the first base 1104, the second base 1106, or both the first base 1104 and the second base 1106 are configured to provide the associated functionality as discussed herein. In some examples, the first base 1104 and the second base 1106 communicate wirelessly to synchronize functionality. In some aspects, first base 1104 and second base 1106 communicate through a wired connection to synchronize the functionality.

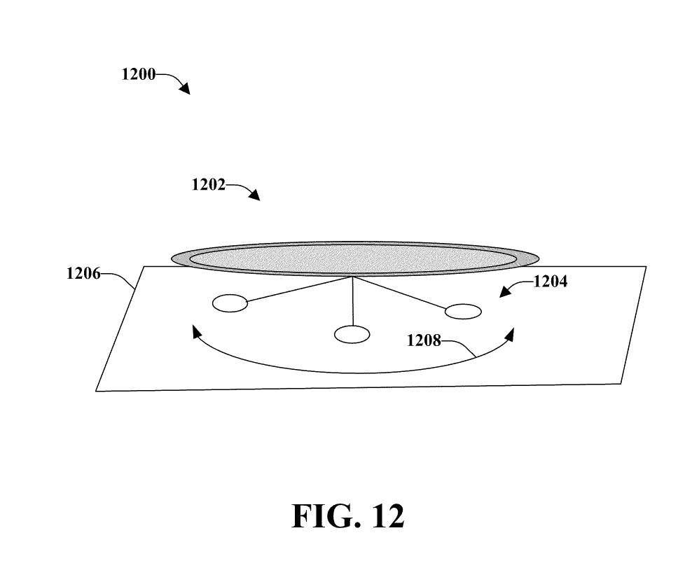

In some aspects, the first base 1104 and second based 1106 are formed with a table or other surface 1112, such as in a restaurant or catering situation. In a restaurant example, a child might have a favorite plate and when the family is eating at a restaurant, the child can bring her favorite plate. An RFID associated with the favorite plate can be identified by at least one of the first base and the second base when the plate is engaged in the bases. In this manner, the child can be presented with the functionality associated with her favorite plate. In an example, if the RFID is not recognized by the bases, the bases can be configured to access the Internet for the associated functionality and/or can access a personal device (e.g., of the parent) to access the desired functionality. In some aspects, platform 102 (of FIG. 3) or other manners of controlling the multifunctional apparatus (e.g., as shown in the example of FIG. 12) can be utilized by a restaurant.

Although two bases are illustrated in FIG. 11, in some aspects only one base might be utilized, provided there is adequate support for the plate. In other aspects, three or more bases are utilized.

FIG. 12 illustrates another example embodiment of a multifunctional apparatus 1200, according to an aspect. In this embodiment, an object, illustrated as a plate 1202 is selectively rotated on a set of wheels 1204, illustrated as a set of three wheels. The wheels can be located under the plate 1202 and are configured to hold the plate a distance away from a surface 1206. The set of wheels 1204 are configured to rotate the plate, as indicated by arrow 1208. Further, the set of wheels 1204 can be configured to provide vibration to the plate. In some aspects, the set of wheels 1204 are attached to plate 1202. However, in some aspects, the set of wheels 1204 are separate from the plate 1202, allowing a multitude of plates to be utilized with the set of wheels 1204.

In some aspects, the set of wheels 1204 comprise a platform (not shown), on which the plate can be placed (e.g., the set of wheels are connected to the platform). The platform can include functionality associated with audible, visual, and/or haptic functionalities. The platform can also provide functionality associated with recognition or synchronization with a plate (e.g., through RFID technology or other technology). However, in some aspects, the functionality is integrated in the set of wheels. In another aspects, the set of wheels receives the functionality wirelessly from a remote device, where the remote device controls the set of wheels. In an example, the remote device can be a remote control. In another example, the remote device can be a computer.

An aspect relates to a multifunctional educational/entertainment apparatus. Apparatus comprises a platform comprising a first attachment means and an object comprising a second attachment means. The first attachment means and the second attachment means are selectively engaged. Apparatus also comprises at least one control for managing at least one function associated with the platform and at least one of a visual, audible, or tactile output that draws attention to the multifunctional educational/entertainment apparatus. The at least one control is an on/off switch. The at least one control is a rotation or a vibration. The at least one control is an audio output or a visual output. According to some aspects, apparatus also comprises a remote control device for controlling operation of the at least one control. The object is dinnerware. The dinnerware is a plate. The object is a children's dinnerware. The object is an electronic children's dinnerware.

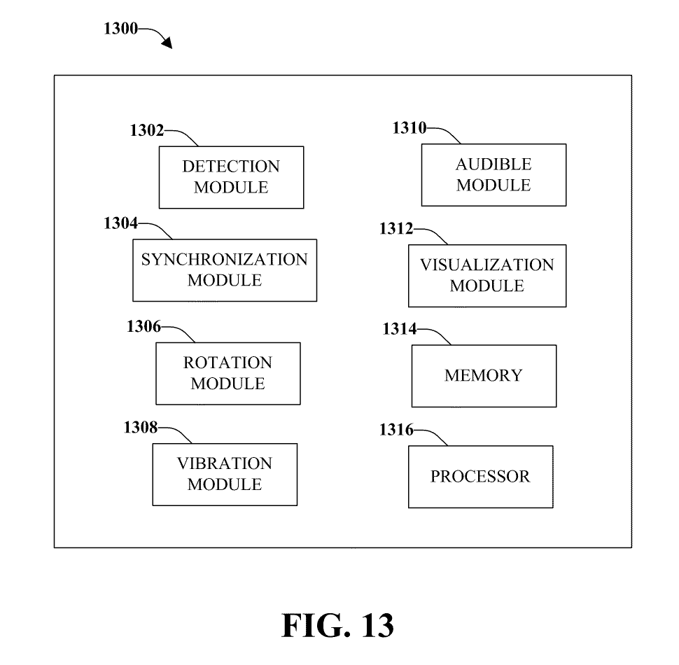

FIG. 13 illustrates a system 1300 for controlling at least one function of a multifunctional apparatus, according to an aspect. In some aspects, system 1300 is included in a platform. However, the disclosed aspects are not limited to this implementation and system 1300 can be included in a plate or other object and/or in a device remote from the multifunctional apparatus. As discussed previously, although the various aspects are discussed herein with respect to a plate, the aspects can apply to other foodware and/or dinnerware and any reference to a plate is to describe the various aspects.

Included in system 1300 is a detection module 1302 configured to automatically identify the plate. In some aspects, the identification is based on a communication means (e.g., identification mechanism, RFID tag) integrated on the plate.

Also included in system 1300 is a synchronization module 1304 configured to match at least one function with the plate. In an aspect, the synchronization or matching can include accessing one or more outputs (e.g., a visual output, an audible output, and/or a haptic output) with the plate, wherein the output is customized for the plate. For example, the plate might depict vegetables and the one or more outputs are related to the depicted vegetables. In another example, the synchronization can include accessing a database or the Internet based on the identification of the plate.

Also included in system 1300 is a rotation module 1306 configured to selectively rotate the plate. For example, the rotation can be based on the synchronization or based on other criteria (e.g., a manual input, detected changes, such as food not being eaten or expiration of a timer). A vibration module 1308 is also included in system 1300. Similar to rotation module 1306, vibration module 1308 is configured to vibrate the plate based on the synchronization or other criteria.

Further, system 1300 can include an audible module 1310 configured to output verbal indicia related to the plate or related to other criteria. For example, the audible module 1310 can output songs, stories, and/or other audio messages based on the matching performed by synchronization module 1304. In another example, the audible module 1310 can output the songs, stories, and/or other audio messages based on a user preference, user selection, historical data, or other parameters. An example of historical information that can be utilized can be that after a carrot song the child always selects a particular song (e.g., “Row, Row, Row, Your Boat”). Knowing this preference of the child, the audible module 1310 can automatically output the particular song after the carrot song, without the child needing to manually select the particular song.

Also included in system 1300 is a visualization module 1312 configured to output one or more lights as a function of the matching performed by synchronization module 1304 or based on other criteria, which can be similar to the criteria utilized by audible module 1310.

In some aspects, system 1300 includes a memory 1314 configured to store information related to identification of the plate, historical data or historical information, user preferences, user information, and so forth. For example, the user information can be utilized if more than one person uses the multifunctional apparatus. For example, a child can utilize the apparatus and, later in the afternoon, the child's mother might utilize the apparatus. However, it is contemplated that the mother would like to receive nutritional information. Although the mother might utilize the same plate as the child (who heard the carrot song), system is configured to detect that it is the mother using the plate in the afternoon (e.g., detection module 1302 (or another module)) can be further configured to detect which user is interacting with multifunctional apparatus (e.g., based on biometrics, a personal device such as a mobile phone, and so forth). In such a manner, system 1300 can automatically supply the mother with the nutritional information and/or nutritional analysis. In some aspects, memory 1314 is associated with a processor 1316 configured to perform one or more functions of modules 1302-1312.

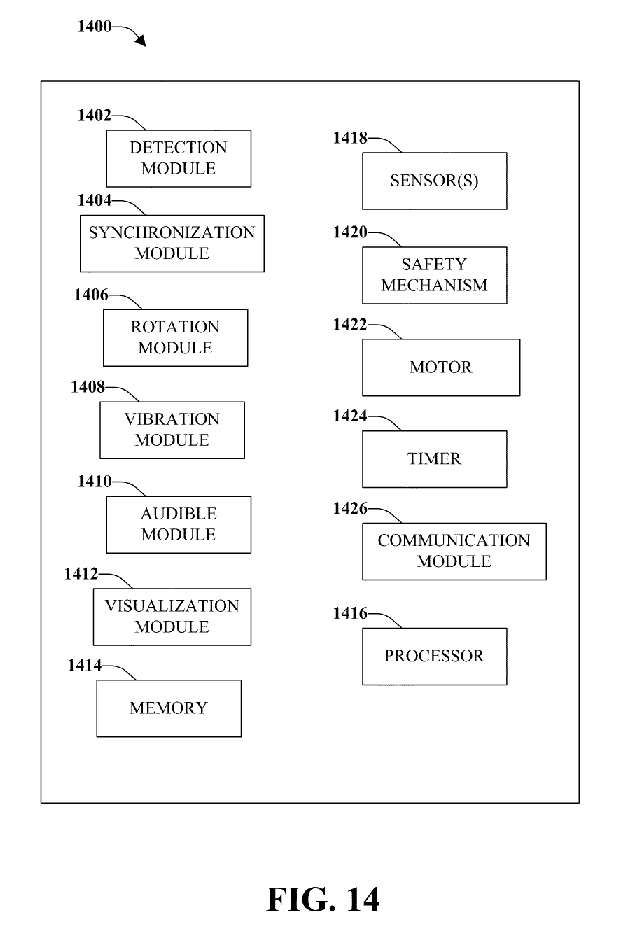

FIG. 14 illustrates a system 1400 for controlling at least one function of a multifunctional apparatus, according to an aspect. In some aspects, system 1400 is included in a platform. However, the disclosed aspects are not limited to this implementation and system 1400 can be included in a plate or other object and/or in a device remote from the multifunctional apparatus. As discussed previously, although the various aspects are discussed herein with respect to a plate, the aspects can apply to other foodware and/or dinnerware and any reference to a plate is to describe the various aspects.

Similar to FIG. 13, system 1400 includes a detection module 1402, a synchronization module 1404, a rotation module 1406, a vibration module 1408, an audible module 1410, a visualization module 1412, memory 1414, and a processor 1416. Also included in system 1400, are one or more sensors 1418. For example, a sensor can detect presence of a user and/or identification a user (as discussed above). In another example, the sensor can detect if a user has left the table. Another example of a sensor is a pressure sensor configured to detect an external force (e.g., pressing on the plate with a fork or a finger). Another sensor can be a weight sensor.

Additionally or alternatively, system 1400 can include a safety mechanism 1420 configured to identify various situations and automatically disable one or more functions associated with modules 1406-1412. In some aspects, the safety mechanism 1420 is configured to temporarily stop rotation of the object upon detection of an external force. For example, safety mechanism 1420 can be configured to detect that the plate is not securely engaged with the platform. This detection can be before the one or more functions are started and/or during operation of the one or more functions (e.g., the child bumps into the plate and dislodges the plate from the platform). Based on the detection that the plate is no longer securely engaged with the platform, safety mechanism 1420 can selectively disable a motor 1422. In some aspects, safety mechanism 1420 can communicate the potentially unsafe condition to one or more modules 1406-1412, which selectively disable respective functionality, based on predefined criteria or other factors.

In some aspects, system 1400 includes a timer 1424 configured to monitor time spent eating and/or interacting with a plate, for example. In some aspects, the timer 1424 is configured to change that at least one function based on an amount of remaining time. In some aspects, the timer is configured to disable the at least one function upon expiration of the timer.

Additionally or alternatively, system 1400 can include a communication module 1426 configured to interact with a remote control device configured to control operations of at least one control. The remote control device can also be configured to selectively disable on-board controls included in system 1400.

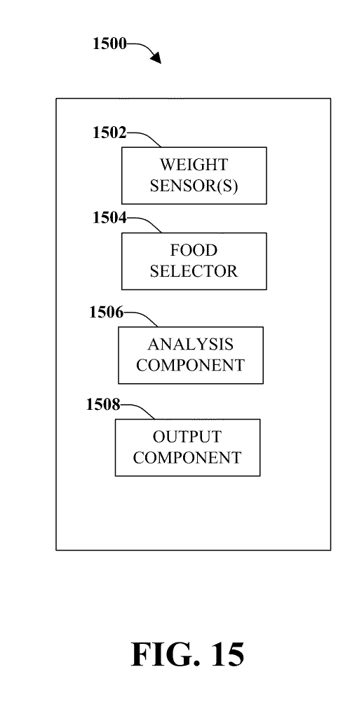

FIG. 15 illustrates another aspect of a system 1500, according to an aspect. System 1500 can include the various modules and components as illustrated with respect to FIGS. 13 and 14. In additional, system 1500 can include a plurality of weight sensors 1502 configured to weigh a plurality of compartments included on the plate. A food selector 1504 is configured to receive an input (e.g., manual input, automatic input based on synchronization with the plate, and so on) related to food contained in at least one of the compartments. An analysis component 1506 is configured to analyze nutritional information of the food as a function of the weight and the food. Also included in system 1500 is an output component 1508 configured to present the nutritional information in a perceivable format. In some aspects, output component 1508 can convey the information to an external or remote device.

In accordance with some aspects, the various aspects (e.g., in connection with receiving one or more selections, analyzing information, synchronizing with an object, implementation of one or more functions, and so forth) can employ various artificial intelligence-based schemes for carrying out various aspects thereof. For example, a process for determining if a particular function should be performed (e.g., based on user preference and/or historical information) can be enabled through an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of functions, for example, attributes can be identification of a particular function (e.g., lights, sound, rotation, vibration) and the classes are criteria of the various functions that need to be utilized to satisfy the request.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the one or more aspects can employ classifiers that are explicitly trained (e.g., through a generic training data) as well as implicitly trained (e.g., by observing user behavior, receiving extrinsic information). For example, SVM's are configured through a learning or training phase within a classifier constructor and feature selection module. Thus, the classifier(s) can be used to automatically learn and perform a number of functions, including but not limited to determining according to a predetermined criteria when to output a function, which functions to utilize together, when to stop one or more functions, and so forth. The criteria can include, but is not limited to, similar requests, historical information, and so forth.

An aspect relates to an apparatus that includes a platform comprising a first attachment means. Also included in apparatus is an object comprising a second attachment means, wherein the first attachment means and the second attachment means are selectively engaged. Further, apparatus includes at least one control for managing at least one function associated with the platform, wherein the at least one function is a visual, audible, or haptic output, and wherein the platform is configured to automatically identify the object and associate the at least one function with the object.

In an implementation, the object comprises an identification tag configured to output information related to the object and the platform comprises an identification reader configured to interpret the information related to the object. In another implementation, the haptic output is rotation, wherein the platform is configured to rotate the object as a function of the automatic identification. In a further implementation, the haptic output is vibration, wherein the platform is configured to vibrate the object as a function of the automatic identification.

In another implementation, the visual function is at least one light configured to illuminate as a function of the automatic identification. In a further implementation, the audible function is a song, story, or message associated with the object.

In some implementations, the apparatus includes a timer configured to change the at least one function based on an amount of remaining time or configured to disable the at least one function upon expiration of the timer. In other implementations, the apparatus includes a safety mechanism configured to temporarily stop rotation of the object upon detection of an external force. In some implementations, the apparatus includes a remote control device configured to control operation of the at least one control and configured to selectively disable on-board controls included on the platform. In an implementation, the object is dinnerware.

According to an implementation, the apparatus further includes a plurality of weight sensors configured to weigh a plurality of compartments included on the object and a food selector configured to receive an input related to food contained in at least one of the plurality of compartments. Further to this implementation, the apparatus also includes an analysis component configured to analyze nutritional information of the food as a function of the weight and the food and an output component configured to present the nutritional information in a perceivable format.

In some implementations, the apparatus includes a safety mechanism configured to disable the at least one function if the first attachment means and the second attachment means are not securely engaged. In some implementations, the at least one control is a manual on/off switch. In some implementations, the apparatus is a single unit.

In another aspect is an apparatus that includes an eating surface comprising a printed pattern, a non-eating surface comprising a first attachment means, and an identification module configured to provide information related to the printed pattern. In an implementation, the first attachment means is configured to securely engage a second attachment means of a platform.

Another aspect relates to an apparatus that includes a movable portion configured to move an object placed in contact with the movable portion. Also included in apparatus is an identification module configured to analyze an identification of the object and an output module configured to implement an action as a function of the identification of the object, the action is implemented while the object is on the movable portion. In some implementations, the function is rotation, wherein the movable portion is configured to rotate the object based on the identification. In an implementation, the function is vibration, wherein the movable portion is configured to vibrate the object based on the identification. In some implementations, the object is foodware.

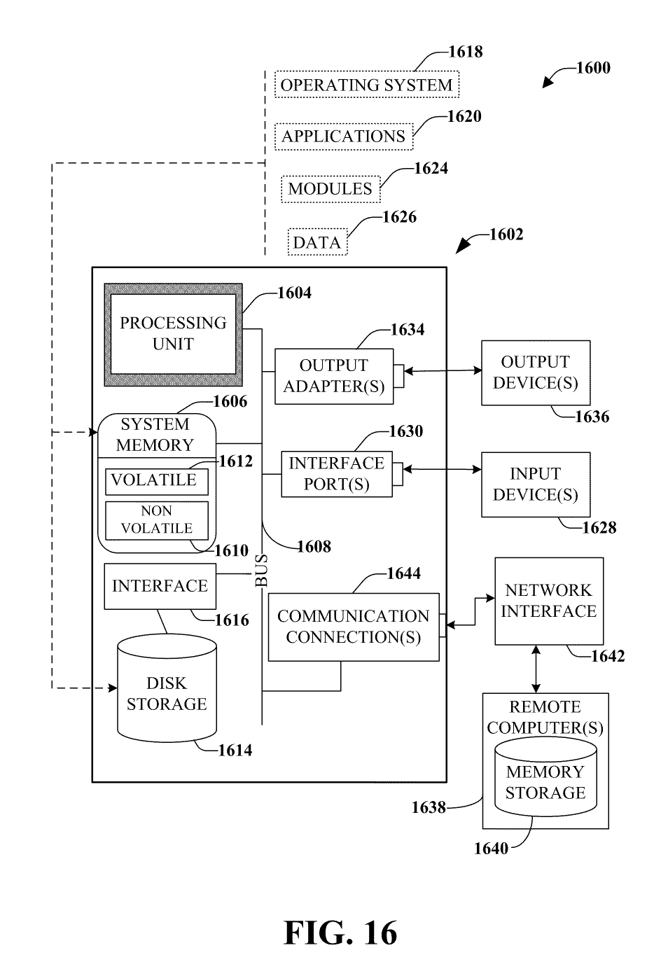

Referring now to FIG. 16, illustrated is a block diagram of a computer operable to execute the disclosed system. In order to provide additional context for various aspects thereof, FIG. 16 and the following discussion are intended to provide a brief, general description of a suitable computing environment 1600 in which the various aspects of the embodiment(s) can be implemented. While the description above is in the general context of computer-executable instructions that may run on one or more computers, those skilled in the art will recognize that the various embodiments can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the various embodiments may also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules, or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16, the illustrative environment 1600 for implementing various aspects includes a computer 1602, which includes a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures may also be employed as the processing unit 1604.

The system bus 1608 can be any of several types of bus structure that may further interconnect to a memory bus (with or without a memory controller), a peripheral bus, and a local bus using any of a variety of commercially available bus architectures. The system memory 1606 includes read-only memory (ROM) and random access memory (RAM) 1612. A basic input/output system (BIOS) is stored in a non-volatile memory 1210 such as ROM, EPROM, EEPROM, which BIOS contains the basic routines that help to transfer information between elements within the computer 1602, such as during start-up. The RAM 1612 can also include a high-speed RAM such as static RAM for caching data.

The computer 1602 further includes a disk storage 1614, which can include an internal hard disk drive (HDD) (e.g., EIDE, SATA), which internal hard disk drive may also be configured for external use in a suitable chassis (not shown), a magnetic floppy disk drive (FDD), (e.g., to read from or write to a removable diskette) and an optical disk drive, (e.g., reading a CD-ROM disk or, to read from or write to other high capacity optical media such as the DVD). The hard disk drive, magnetic disk drive and optical disk drive can be connected to the system bus by a hard disk drive interface, a magnetic disk drive interface and an optical drive interface, respectively. The interface 1616 for external drive implementations includes at least one or both of Universal Serial Bus (USB) and IEEE 1094 interface technologies. Other external drive connection technologies are within contemplation of the various embodiments described herein.

The drives and their associated computer-readable media provide nonvolatile storage of data, data structures, computer-executable instructions, and so forth. For the computer 1602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed aspects.

A number of program modules can be stored in the drives and RAM, including an operating system 1618, one or more application programs 1620, other program modules 1624 and program data 1626. All or portions of the operating system, applications, modules, and/or data can also be cached in the RAM. It is to be appreciated that the various embodiments can be implemented with various commercially available operating systems or combinations of operating systems.

A user can enter commands and information into the computer 1602 through one or more wired/wireless input devices 1628, such as a keyboard and a pointing device, such as a mouse. Other input devices may include a microphone, an IR remote control, a joystick, a game pad, a stylus pen, touch screen, or the like. These and other input devices are often connected to the processing unit 1604 through an input device interface 1630 that is coupled to the system bus 1608, but can be connected by other interfaces, such as a parallel port, an IEEE 1094 serial port, a game port, a USB port, an IR interface, etc.

A monitor or other type of display device is also connected to the system bus 1608 via an output (adapter) port 1634, such as a video adapter. In addition to the monitor, a computer typically includes other peripheral output devices 1636, such as speakers, printers, etc.

The computer 1602 may operate in a networked environment using logical connections via wired and/or wireless communications to one or more remote computers, such as a remote computer(s) 1638. The remote computer(s) 1638 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1240 is illustrated.

The remote computer(s) can have a network interface 1642 that enables logical connections to computer 1602. The logical connections include wired/wireless connectivity to a local area network (LAN) and/or larger networks, e.g., a wide area network (WAN). Such LAN and WAN networking environments are commonplace in homes, offices, and companies, and facilitate enterprise-wide computer networks, such as intranets, all of which may connect to a global communications network, e.g., the Internet.

When used in a LAN networking environment, the computer 1602 is connected to the local network through a wired and/or wireless communication network interface or adapter (communication connection(s) 1644). The adaptor 1644 may facilitate wired or wireless communication to the LAN, which may also include a wireless access point disposed thereon for communicating with the wireless adaptor.

When used in a WAN networking environment, the computer 1602 can include a modem, or is connected to a communications server on the WAN, or has other means for establishing communications over the WAN, such as by way of the Internet. The modem, which can be internal or external and a wired or wireless device, is connected to the system bus 1608 via the serial port interface. In a networked environment, program modules depicted relative to the computer 1602, or portions thereof, can be stored in the remote memory/storage device 1640. It will be appreciated that the network connections shown are illustrative and other means of establishing a communications link between the computers can be used.

The computer 1602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, and so forth), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+Mbps in the 2.4 GHz band. Products can contain more than one band (e.g., dual band), so the networks can provide real-world performance similar to the basic 10BaseT wired Ethernet networks used in many offices and/or homes.

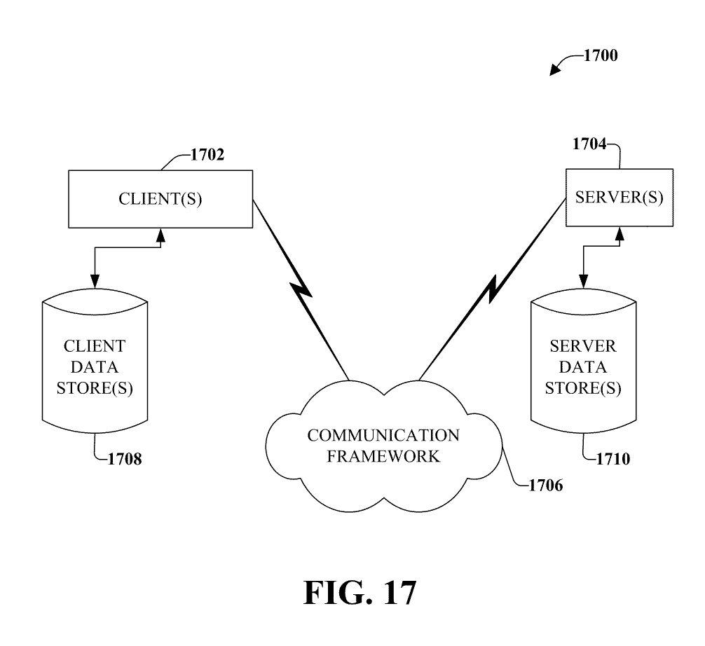

Referring now to FIG. 17, there is illustrated a schematic block diagram of an illustrative computing environment 1700 for processing the disclosed architecture in accordance with another aspect. The environment 1700 includes one or more client(s) 1702. The client(s) 1702 can be hardware and/or software (e.g., threads, processes, computing devices). The client(s) 1702 can house cookie(s) and/or associated contextual information in connection with the various embodiments, for example.

The environment 1700 also includes one or more server(s) 1704. The server(s) 1704 can also be hardware and/or software (e.g., threads, processes, computing devices). The servers 1704 can house threads to perform transformations in connection with the various embodiments, for example. One possible communication between a client 1702 and a server 1704 can be in the form of a data packet adapted to be transmitted between two or more computer processes. The data packet may include a cookie and/or associated contextual information, for example. The environment 1700 includes a communication framework 1706 (e.g., a global communication network such as the Internet) that can be employed to facilitate communications between the client(s) 1702 and the server(s) 1704.

Communications can be facilitated via a wired (including optical fiber) and/or wireless technology. The client(s) 1702 are operatively connected to one or more client data store(s) 1708 that can be employed to store information local to the client(s) 1702 (e.g., cookie(s) and/or associated contextual information). Similarly, the server(s) 1704 are operatively connected to one or more server data store(s) 1710 that can be employed to store information local to the servers 1704.

As used in this application, the terms “component”, “module”, “object”, “service”, “model”, “representation”, “system”, “interface”, or the like are generally intended to refer to a computer-related entity, either hardware, a combination of hardware and software, software, or software in execution. For example, a component can be, but is not limited to being, a process running on a processor, a processor, a hard disk drive, a multiple storage drive (of optical and/or magnetic storage medium), an object, an executable, a thread of execution, a program, and/or a computer. By way of illustration, both an application running on a controller and the controller can be a component. One or more components can reside within a process and/or thread of execution and a component can be localized on one computer and/or distributed between two or more computers, industrial controllers, or modules communicating therewith. As another example, an interface can include I/O components as well as associated processor, application, and/or API components.

The subject matter as described above includes various exemplary aspects. However, it should be appreciated that it is not possible to describe every conceivable component or methodology for purposes of describing these aspects. One of ordinary skill in the art may recognize that further combinations or permutations may be possible. Various methodologies or architectures may be employed to implement the subject invention, modifications, variations, or equivalents thereof. Accordingly, all such implementations of the aspects described herein are intended to embrace the scope and spirit of subject claims. Furthermore, to the extent that the term “includes” is used in either the detailed description or the claims, such term is intended to be inclusive in a manner similar to the term “comprising” as “comprising” is interpreted when employed as a transitional word in a claim.

In view of exemplary systems shown and described herein, methodologies for manufacturing, assembling, and using a multifunctional apparatus may be implemented in accordance with the disclosed subject matter.

The various aspects disclosed herein can be performed in association with electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In accordance with some aspects, a user can enter commands and information into the multifunctional apparatus through one or more wired/wireless input devices (e.g., a keyboard and a pointing device, such as a mouse). Other input devices may include a microphone, an IR remote control, a joystick, a game pad, a stylus pen, touch screen, or the like. These and other input devices are often connected to a processing unit through an input device interface that is coupled to a system bus, but can be connected by other interfaces, such as a parallel port, an IEEE 1394 serial port, a game port, a USB port, an IR interface, etc.

While the foregoing disclosure discusses illustrative aspects and/or embodiments, it should be noted that various changes and modifications could be made herein without departing from the scope of described aspects and/or embodiments as defined by the appended claims. Accordingly, described aspects are intended to embrace all such alterations, modifications and variations that fall within scope of appended claims. Furthermore, although elements of described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features are presented in terms of systems that may include a number of devices, components, modules, and the like. It is to be understood and appreciated that various systems may include additional devices, components, modules, and so forth, and/or may not include all devices, components, modules, and so on, discussed in connection with the figures. A combination of these approaches may also be used.

Additionally, in the subject description, the word “exemplary” (and variants thereof) is used to mean serving as an example, instance, or illustration. Any aspect or design described herein as “exemplary” is not necessarily to be construed as preferred or advantageous over other aspects or designs. Rather, use of the word “exemplary” is intended to present concepts in a concrete manner.

What is claimed is:

1. An apparatus, comprising:
a platform comprising a first attachment means;
an object comprising a second attachment means, wherein the first attachment means and the second attachment means are selectively engaged; and
at least one control for managing at least one function associated with the platform, wherein the at least one function is a visual, audible, or haptic output, and wherein the platform is configured to automatically identify the object and associate the at least one function with the object.

2. The apparatus of claim 1, wherein the object comprises an identification tag configured to output information related to the object and the platform comprises an identification reader configured to interpret the information related to the object.

3. The apparatus of claim 1, wherein the haptic output is rotation, wherein the platform is configured to rotate the object as a function of the automatic identification.

4. The apparatus of claim 1, wherein the haptic output is vibration, wherein the platform is configured to vibrate the object as a function of the automatic identification.

5. The apparatus of claim 1, wherein the visual function is at least one light configured to illuminate as a function of the automatic identification.

6. The apparatus of claim 1, wherein the audible function is a song, story, or message associated with the object.

7. The apparatus of claim 1, further comprising a timer configured to change the at least one function based on an amount of remaining time or configured to disable the at least one function upon expiration of the timer.

8. The apparatus of claim 1, further comprising a safety mechanism configured to temporarily stop rotation of the object upon detection of an external force.

9. The apparatus of claim 1, further comprising a remote control device configured to control operation of the at least one control and configured to selectively disable on-board controls included on the platform.

10. The apparatus of claim 1, wherein the object is dinnerware.

11. The apparatus of claim 1, further comprising:
a plurality of weight sensors configured to weigh a plurality of compartments included on the object;
a food selector configured to receive an input related to food contained in at least one of the plurality of compartments;
an analysis component configured to analyze nutritional information of the food as a function of the weight and the food; and
an output component configured to present the nutritional information in a perceivable format.

12. The apparatus of claim 1, further comprising a safety mechanism configured to disable the at least one function if the first attachment means and the second attachment means are not securely engaged.

13. The apparatus of claim 1, wherein the at least one control is a manual on/off switch.

14. The apparatus of claim 1 is a single unit.

15. An apparatus, comprising:
an eating surface comprising a printed pattern;
a non-eating surface comprising a first attachment means; and
an identification module configured to provide information related to the printed pattern.

16. The apparatus of claim 15, wherein the first attachment means is configured to securely engage a second attachment means of a platform.

17. An apparatus, comprising:
a movable portion configured to move an object placed in contact with the movable portion;
an identification module configured to analyze an identification of the object; and
an output module configured to implement an action as a function of the identification of the object, the action is implemented while the object is on the movable portion.

18. The apparatus of claim 17, wherein the function is rotation, wherein the movable portion is configured to rotate the object based on the identification.

19. The apparatus of claim 17, wherein the function is vibration, wherein the movable portion is configured to vibrate the object based on the identification.

20. The apparatus of claim 17, wherein the object is foodware.
